(19) United States
(12) Patent Application Publication
(10) Pub. No.: US 2009/0075162 A1
(43) Pub. Date: Mar. 19, 2009

(54) POWER SUPPLY APPARATUS

(76) Inventor: Izumi Takahashi, Aichi (JP)

Correspondence Address: KENYON & KENYON LLP, 1500 K STREET N.W., SUITE 700, WASHINGTON, DC, 20005, US

(21) Appl. No.: 12/299,163

(22) PCT Filed: Feb. 14, 2008
(86) PCT No.: PCT/JP2008/052397

§ 371 Date: Oct. 31, 2008

(30) Foreign Application Priority Data
Feb. 20, 2007 (JP) 2007-038880

(51) Int. Cl. H01M 10/50

(52) U.S. Cl. 429/120

(57) ABSTRACT

A power supply apparatus wherein a liquid medium is housed so as to provide an air layer in a first case which accommodates a power supply unit. When the liquid medium is heated to a temperature higher than a vaporization temperature by external heat toward the power supply unit, the liquid medium is vaporized to increase the volume of the air layer to reduce heat conduction of the external heat toward the power supply unit. Since this can reduce the heat conduction of the external heat toward the power supply unit, it is possible to prevent an extreme increase in temperature of the power supply unit due to the external heat.

### TECHNICAL FIELD

The present invention relates to a power supply apparatus which includes a power supply unit therein.

### BACKGROUND ART

Secondary batteries generate heat in charge and discharge and suffer accelerated deterioration at a temperature higher than a proper level. It is thus necessary to radiate heat thereof smoothly. Patent Document 1 has disclosed a cooling system described below as a method of promoting heat radiation in a secondary battery.

The cooling system includes an assembled battery to be cooled, A box which accommodates the assembled battery and is filed with a coolant, a circulatory path through which the coolant is ejected from the box and injected into the box, a pump which is provided for the circulatory path to circulate the coolant through the circulatory path, and a radiator which cools the coolant in the circulatory path. When the assembled battery of this type is used as a driving or auxiliary power supply in an electric car or a hybrid car, the assembled battery can be fixed at a position where favorable heat radiation is provided, for example, on a floor panel.

With the abovementioned structure, when the assembled battery in a vehicle generates heat in charge and discharge during driving thereof, the assembled battery can be cooled with the coolant cooled by the radiator.

[Patent Document 1] Japanese Patent Laid-Open No. 2003-346924

### DISCLOSURE OF THE INVENTION

### Problems to be Solved by the Invention

When the ignition is off in the vehicle to stop the abovementioned cooling system, heat may be transferred from the floor panel and applied to the assembled battery. This may extremely increase the temperature of the assembled battery to promote deterioration of the assembled battery.

It is an object of the present invention to prevent an increase in temperature of a power supply unit due to external heat.

### Means for Solving Problems

To solve the abovementioned problem, the present invention provides a power supply apparatus wherein a liquid medium is housed so as to provide an air layer in a first case which accommodates a power supply unit. When the liquid medium is heated to a temperature higher than a vaporization temperature by external heat toward the power supply unit, the liquid medium is vaporized to increase the volume of the air layer to reduce heat conduction of the external heat toward the power supply unit.

The liquid medium is vaporized at a temperature lower than the upper limit of a proper temperature range for the power supply unit. A heat-radiating fin may be formed on an outer surface of the first case.

The power supply unit includes a power supply portion and a second case which accommodates a coolant, the coolant cools the power supply portion, and the first case is in contact with an outer surface of the second case.

The first case includes a liquid housing portion which houses the liquid medium and a guide surface which guides the liquid medium to the liquid housing portion after the liquid medium is once vaporized by the external heat and then changed into a liquid.

The power supply apparatus includes an electromechanical energy converting element which is placed between a vehicle heat-radiating portion for radiating heat in the power supply unit to the outside of a vehicle and the second case and is switched between a contact state in which the element is in contact with the second case and the vehicle heat-radiating portion in response to application of a voltage and a non-contact state in which the element is not in contact with the second case and/or the vehicle heat-radiating portion, and a control means for controlling application of a voltage to the electromechanical energy converting element.

The power supply apparatus includes an electromechanical energy converting element which is placed between a vehicle heat-radiating portion for radiating heat in the power supply unit to the outside of a vehicle and the second case and is switched between a contact state in which the element is in contact with the second case and the vehicle heat-radiating portion in response to application of a voltage and a non-contact state in which the element is not in contact with the second case and/or the vehicle heat-radiating portion, and a control circuit for controlling application of a voltage to the electromechanical energy converting element.

### Effects of the Invention

According to the present invention, when the liquid medium is heated to a temperature higher than the vaporization temperature by external heat toward the power supply unit, the liquid medium can be vaporized to increase the volume of the air layer to reduce heat conduction of the external heat toward the power supply unit. It is thus possible to prevent an extreme increase in temperature of the power supply unit due to the external heat.

### BRIEF DESCRIPTION OF DRAWINGS

FIG. 1 A perspective view showing a passenger seat.

FIGS. 2A A section views illustrating the power supply apparatus before a liquid medium is vaporized.

FIGS. 2B A section views illustrating the power supply apparatus after part of the liquid medium is vaporized. Section views showing a power supply apparatus.

FIG. 3 A block diagram for explaining application of a voltage to a piezoelectric element in accordance with a battery temperature.

FIG. 4 A flow chart illustrating a method of temperature adjustment in the power supply apparatus.

FIG. 5 A section view showing the power supply apparatus when a piezoelectric element is set in a contact state.

FIG. 6 A section view showing a power supply apparatus of Modification 1.

FIG. 7 A section view showing a power supply apparatus of Modification 2.

FIGS. 8A A section views showing a power supply apparatus before a liquid medium is vaporized (Embodiment 2).

FIGS. 8B A section views showing a power supply apparatus after part of the liquid medium is vaporized. (Embodiment 2).

### DESCRIPTION OF REFERENCE NUMERALS

2 POWER SUPPLY APPARATUS

21 CYLINDRICAL ELECTRICAL CELL

22 ASSEMBLED BATTERY

23 COOLANT

24 POWER SUPPLY CASE

25 BRACKET

26 PIEZOELECTRIC ELEMENT

29 LIQUID MEDIUM

30, 300 MEDIUM HOUSING CASE

30a SECOND MEDIUM HOUSING CASE

30b FIRST MEDIUM HOUSING CASE

31 HEAT-RADIATING FIN

300a INCLINED SURFACE

### BEST MODE FOR CARRYING OUT THE INVENTION

Preferred embodiments of the present invention will hereinafter be described.

### Embodiment 1

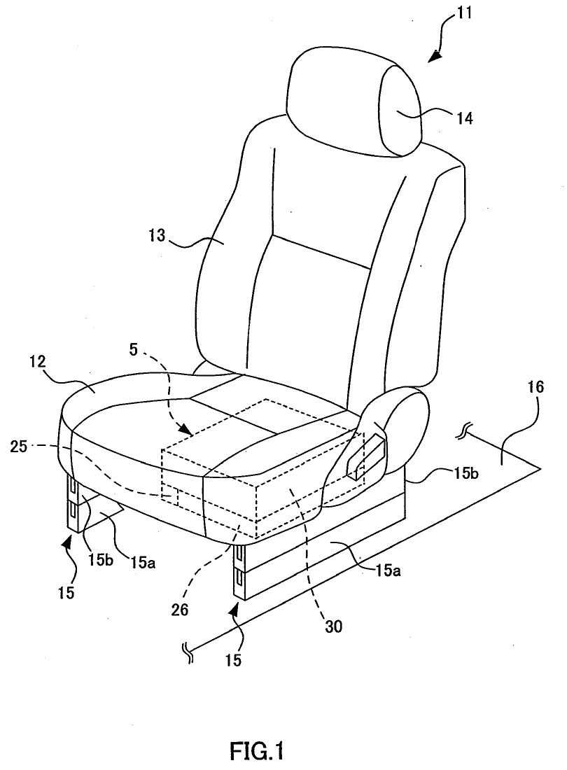

FIG. 1 is a perspective view showing a passenger seat 11 of a vehicle. The passenger seat 11 has a seat 12 and a back rest 13. A head rest 14 is removably attached to the top end of the back rest 13. A pair of seat rails 15 is provided under the seat 12 to extend in a front-to-back direction and opposite to each other in a width direction.

Each of the seat rails 15 is formed of a lower rail 15a fixed onto a floor panel (vehicle heat-radiating portion) 16 and an upper rail 15b fixed to a lower surface of the seat 12. The upper rail 15b is slidable over the lower rail 15a in a longitudinal direction thereof and is guided by the lower rail 15a. The seat rails 15 allow adjustments of the position of the passenger seat 11 in the front-to-back direction of the vehicle.

A power supply apparatus 2 is provided between the paired seat rails 15. The power supply apparatus 2 is fixed to the floor panel 16 and is used as a driving power source of a hybrid vehicle.

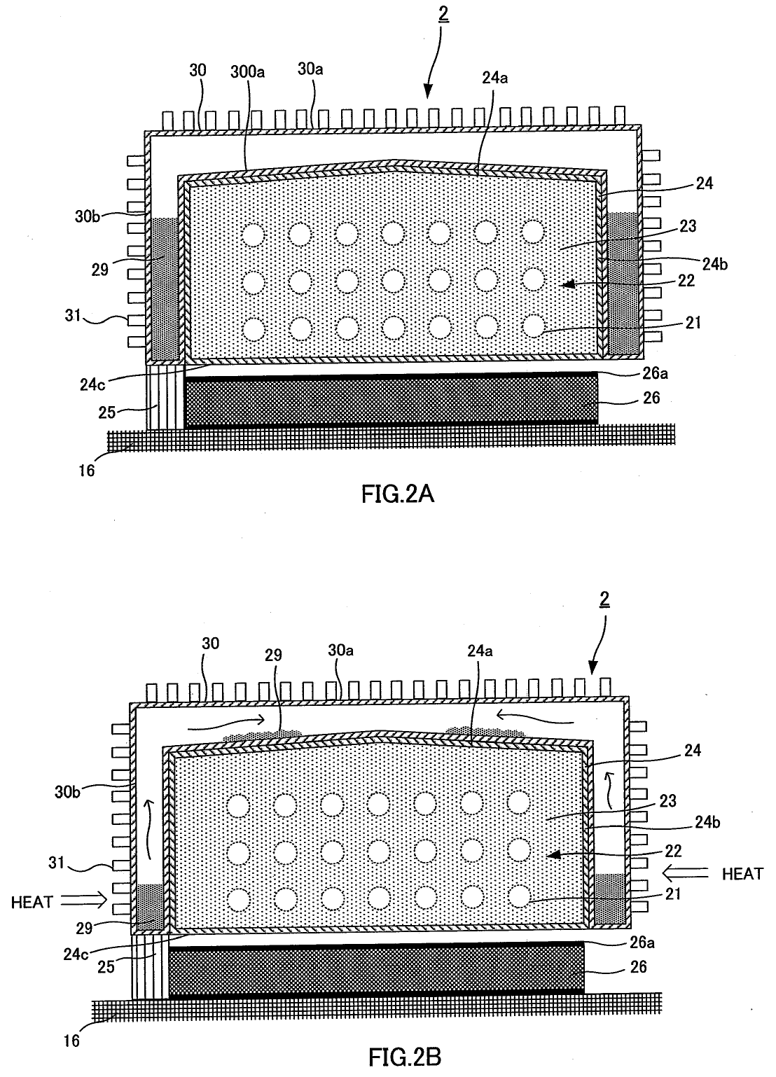

Next, the configuration of the power supply apparatus 2 will be described with reference to FIGS. 1 and 2. FIGS. 2A and 2B are section views illustrating the power supply apparatus 2, in which FIG. 2A shows the apparatus 2 before a liquid medium is vaporized and FIG. 2B shows the apparatus 2 after part of the liquid medium is vaporized.

In FIGS. 2A and 2B, the power supply apparatus 2 includes an assembled battery (power supply portion) 22 which includes a plurality of cylindrical electrical cells 21 arranged in parallel, a coolant 23 which cools the assembled battery 22, and a power supply case (second case) 24 which accommodates the assembled battery 22 and the coolant 23. A lithium-ion battery can be used as each of the cylindrical electrical cells 21.

The lithium-ion battery is increasingly deteriorated at a battery temperature higher than 60° C. and cannot provide a sufficient output at a battery temperature lower than 25° C. For this reason, the battery temperature of each of the cylindrical electrical cells 21 is preferably adjusted to fall within a range from 25 to 60° C. (proper temperature range). Each of the cylindrical electrical cells 21 may be formed of a nickel metal hydride (NiMH) battery instead. The proper temperature range described in claims refers to a range of battery temperatures required to prevent significant progress of deterioration and to provide a battery output corresponding to a needed output level. The proper temperature range can be changed as appropriate depending on the type of the battery.

Suitable materials for the coolant 23 for the assembled battery 22 include one that has a high specific heat, a high thermal conductivity, and a high boiling point, does not corrode the power supply case 24 or the assembled battery 22, and has resistance to thermal decomposition, air oxidation, and electrolysis. An electrical insulating liquid is desirable to prevent short-circuit between electrode terminals. For example, a fluorine-containing inert liquid can be used. Examples of the fluorine-containing inert liquid may include Fluorinert manufactured by 3M, Novec HFE (hydrofluoroether), and Novec1230. A liquid other than the fluorine-containing inert liquid may be used (for example, silicone oil).

The power supply case 24 is formed of a case upper-wall portion 24a, a case side-wall portion 24b, and a case lower-wall portion 24c. The case side-wall portion 24b and the case lower-wall portion 24c are integrally formed, while the case upper-wall portion 24a is formed as a separate component from the case side-wall portion 24b and the case lower-wall portion 24c.

The case upper-wall portion 24a is formed in a pyramidal shape with its portions inclined downward outwardly in a horizontal direction of the power supply case 24.

A medium housing case (first case) 30 which accommodates a liquid medium 29 in part thereof is attached to an outer surface of the power supply case 24 (except for an outer surface of the case lower-wall portion 24c). The medium housing case 30 is formed of a first medium housing case portion(liquid housing portion) 30b on the periphery of the case side-wall portion 24b and a second medium housing case portion 30a on the periphery of the case upper-wall portion 24a. The medium housing case 30 is in contact with the case upper-wall portion 24a and the case side-wall portion 24b to hold the power supply case 24. The first and second medium housing cases 30b and 30a communicate with each other.

The first medium housing case portion 30b accommodates the liquid medium 29. The liquid medium 29 surrounds generally the assembled battery 22 in the horizontal direction before the liquid medium 29 is vaporized (see FIG. 2A).

An air layer (gas layer) is provided in part of the first medium housing case portion 30b (in an area above the liquid level of the liquid medium 29) and in the second medium housing case portion 30a. The liquid medium 29 can be realized by using a fluorine-containing inert liquid and is vaporized when the liquid temperature reaches 55° C. under atmospheric pressure.

The medium housing case 30 may have a volume set such that part of the liquid medium 29 can be vaporized as shown in FIG. 2B or all the liquid medium 29 can be vaporized.

The wall portion of the second medium housing case portion 30a closer to the power supply case 24 is inclined downward outwardly in the horizontal direction of the power supply case 24 similarly to the case upper-wall portion 24a. Thus, after the liquid medium 29 is once vaporized in the first medium housing case portion 30b and cooled in the second medium housing case portion 30a to be changed into liquid form, the liquid medium 29 can be returned to the first medium housing case portion 30a along the wall portion of the second medium housing case portion 30b by gravity.

A plurality of heat-radiating fines 31 are formed on an outer surface of the medium housing case 30. The heat-radiating fins 31 increase the area in contact with outside air to promote heat radiation of the power supply apparatus 2. This allows the once vaporized liquid medium 29 to be returned to a liquid state readily.

A bracket 25 for fixing the power supply apparatus 2 to the floor panel 16 is provided on a lower surface of the medium housing case 30. The bracket 25 can support the power supply apparatus 2 at a position separated from the floor panel 16. The bracket 25 may be formed of resin, for example.

A piezoelectric element (electromecanical energy converting element) 26 is provided between the case lower-wall portion 24c and the floor panel 16 and is fixed onto the floor panel 16. The piezoelectric element 26 may be formed of a conductive polymer or an electrostriction elastomer, for example.

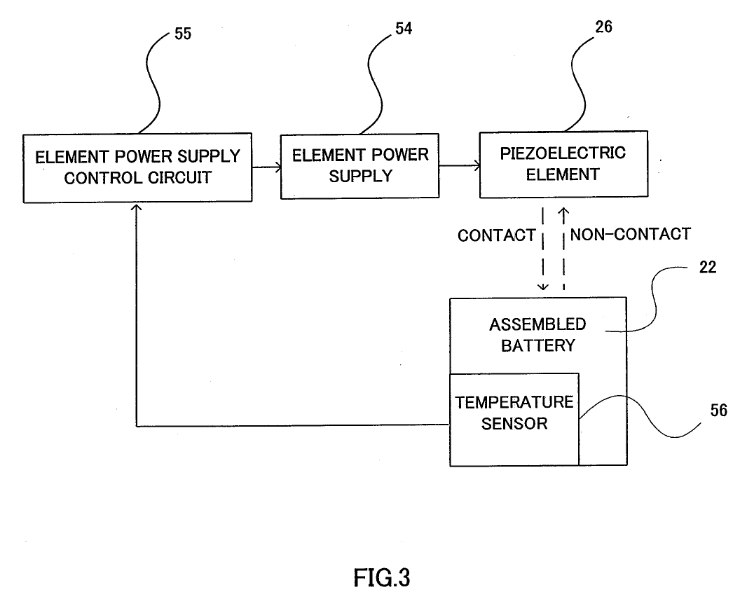

The piezoelectric element 26 is provided with electrode portions 26a on both end faces in a vertical direction (on surfaces in contact with the case lower-wall portion 24c and the floor panel 16). The electrode portions 26a are electrically connected to a direct-current element power supply 54 for applying a voltage to the piezoelectric element 26 (see FIG. 3). The application of a voltage to the piezoelectric element 26 by the element power supply 54 is controlled by an element power supply control circuit 55.

As shown in FIG. 3, the element power supply control circuit 55 controls the application of a voltage based on information (temperature information) output from a temperature sensor 56 provided for the assembled battery 22.

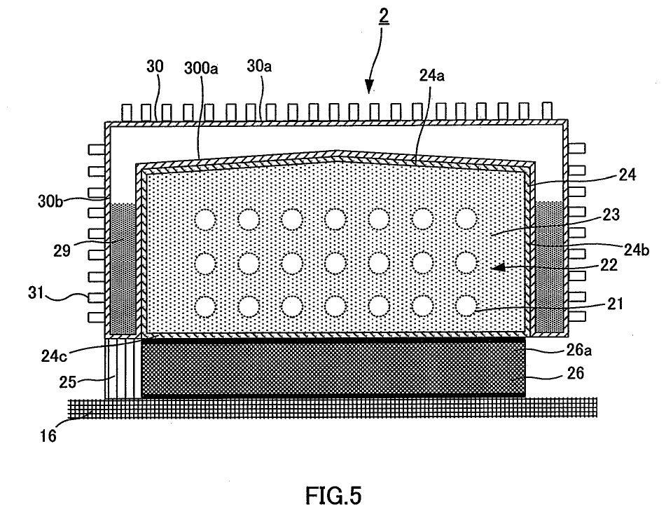

When no voltage is applied to the piezoelectric element 26 by the element power supply 54, the piezoelectric element 26 is separated from the power supply case 24 as shown in FIGS. 2A and 2B (hereinafter referred to as a non-contact state). When a voltage is applied to the piezoelectric element 26 in the non-contact state, the piezoelectric element 26 is extended in the vertical direction and brought into contact with the power supply case 24 as shown in FIG. 5 (hereinafter referred to as a contact state).

The piezoelectric element 26 includes an insulating filler (for example, aluminum nitride or aluminum oxide). The insulating filler can increase the heat conductivity of the piezoelectric element 26 to promote heat radiation from the assembled battery 22 to the floor panel 16.

Next, the method of cooling the assembled battery 22 will be described in the respective cases where the ignition is off and where the ignition is on in the vehicle.

### When Ignition is Off in Vehicle

When the ignition is off in the vehicle and the vehicle is parked under a high-temperature environment (for example, when the vehicle is parked in a parking area exposed to direct sunlight), heat may be transferred from the floor panel 16 to increase the temperature of the assembled battery 22 to a level above the upper limit of the proper temperatures.

The proper temperatures range from 25° C. to 60° C. for lithium-ion batteries as described above. If a fan (not shown) is provided for cooling the power supply apparatus 2, it is assumed that the fan is stopped in response to the turn-off of the ignition in the vehicle (that is, the cooling means for the power supply apparatus 2 is not operated).

When the ignition is off in the vehicle and the vehicle is parked under a low-temperature environment (for example, when the vehicle is parked in a cold climate region with heavy snow), the cold air may flow into the assembled battery 22 through the floor panel 16 (that is, the heat may escape from the assembled battery 22 through the floor panel 16) to reduce the temperature of the assembled battery 22 to a level below the lower limit of the proper temperatures.

To address these problems, when the ignition is off in the vehicle, the piezoelectric element 26 is separated from the power supply case 24 to form the air layer between the floor panel 16 and the power supply case 24. The air layer can prevent transfer of heat from the outside of the vehicle to the assembled battery 22 through the floor panel 16 and can prevent flowing of heat in the assembled battery 22 to the outside of the vehicle through the floor panel 16.

When the vehicle is parked under a high-temperature environment and heat in the interior of the vehicle flows into the liquid medium through the heat-radiating fins 31 and the like to increase the temperature of the liquid medium 29 to 55° C., part of the liquid medium 29 is vaporized (see FIG. 2B). This can remove the heat flowing into the medium housing case 30 through the evaporation cooling.

The vaporization of part of the liquid medium 29 can drop the liquid level of the liquid medium 29 to increase the volume of the gas layer in the first medium housing case portion 30b. This can reduce the amount of the heat flowing into the power supply case 24 as compared with the amount before the liquid medium 29 is vaporized, thereby preventing an extreme increase in temperature of the assembled battery 22.

Since the air layer is present in the second medium housing case portion 30a at all times, it can prevent external heat from flowing into the power supply case 24 from above the power supply apparatus 2.

The vaporized liquid medium 29 is cooled mainly through the heat-radiating effect of the heat-radiating fins 31 and is returned to a liquid state when the temperature is reduced below 55° C. The liquid medium 29 changed into the liquid state is moved by gravity along an inclined surface (guide surface) 300a formed on an inner surface of the second medium housing case portion 30a and flows into the first medium housing case portion 30b. Then, the liquid medium 29 can be reused.

### When Ignition is On in Vehicle

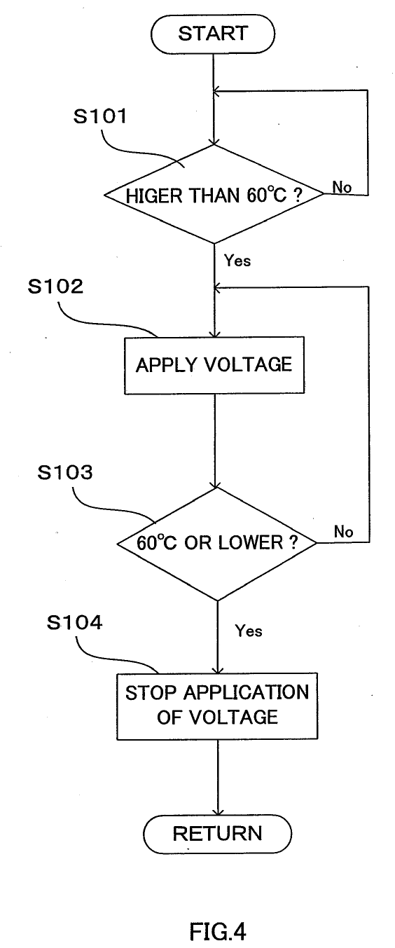

Next, the method of temperature adjustment in the power supply apparatus 2 will be described when the ignition is on in the vehicle with reference to FIG. 4 which is a flow chart showing the method of temperature adjustment in the power supply apparatus 2. The flow chart is performed by the element power supply control circuit 55 which continuously monitors the temperature information output from the temperature sensor 56. The piezoelectric element 26 is separated from the power supply case 24 in the initial state.

First, it is determined whether or not the temperature of the assembled battery 22 is higher than a threshold value (60° C.) based on the temperature information from the temperature sensor 56 (step S101).

When the temperature of the assembled battery 22 is higher than 60° C., a voltage is applied to the piezoelectric element 26 to change the piezoelectric element 26 from the non-contact state to the contact state as shown in FIG. 5 (step S102). If the temperature of the liquid medium 29 is equal to or higher than 55° C. at this point, the volume of the air layer in the medium housing case 30 is increased. Thus, the heat in the assembled battery 22 is mainly escaped toward the floor panel 16 through the piezoelectric element 26.

On the other hand, if the temperature of the liquid medium 29 is lower than 55° C., the heat in the assembled battery 22 is escaped toward the floor panel 16 and the heat-radiating fins 31 through the piezoelectric element 26 and the liquid medium 29.

When the temperature of the assembled battery 22 is reduced to 60° C. or lower (step S103), the application of the voltage to the piezoelectric element 26 is stopped (step S104) to move the piezoelectric element 26 set in the contact state to the non-contact state.

According to the abovementioned method of temperature adjustment, the temperature of the assembled battery 22 can be maintained in the proper range, so that the life of the assembled battery 22 can be extended.

### Modifications

While the piezoelectric element 26 is used to perform control for switching the floor panel 16 and the power supply case 24 between the contact state and the non-contact state in the embodiment described above, a thermo-sensitive deformable element may be used instead. In this case, the thermo-sensitive deformable element which is deformed at a predetermined temperature (for example, 60° C.) may be fixed to the power supply case 24 without any contact with the floor panel 16. When the temperature of the power supply case 24 reaches 60° C., the thermo-sensitive deformable element is deformed and brought into contact with the floor panel 16 to allow radiation of heat in the assembled battery 22.

It is also possible to provide a pressure adjusting portion which adjusts the pressure in the medium housing case 30. If the assembled battery 22 of a different type is used, the vaporization temperature of the liquid medium 29 can be easily changed depending on the proper temperatures of that assembled battery 22 with the pressure adjustment by the pressure adjusting portion.

A gas discharge valve may be provided for the medium housing case 30. The gas discharge valve may be a rupture-type valve formed by partially thinning the wall portion of the medium housing case portion 30b or may be a spring-type self-returning valve.

The rupture-type valve can be broken to release the internal pressure of the medium housing case 30 to the outside of the power supply apparatus 2 if the internal pressure of the medium housing case 30 is increased.

The spring-type self-returning valve can be formed by movably providing a movable valve in an opening formed in the wall portion of the medium housing case 30 and attaching a spring to the movable valve.

If the internal pressure of the medium housing case 30 is increased, the movable valve can be retracted from the opening against the spring force of the spring to allow release of the pressure inside the medium housing case 30 through the opening. If the internal pressure of the medium housing case 30 is reduced, the movable spring is returned into the opening by the spring force of the spring. In this manner, an extreme increase in internal pressure of the medium housing case 30 can be prevented.

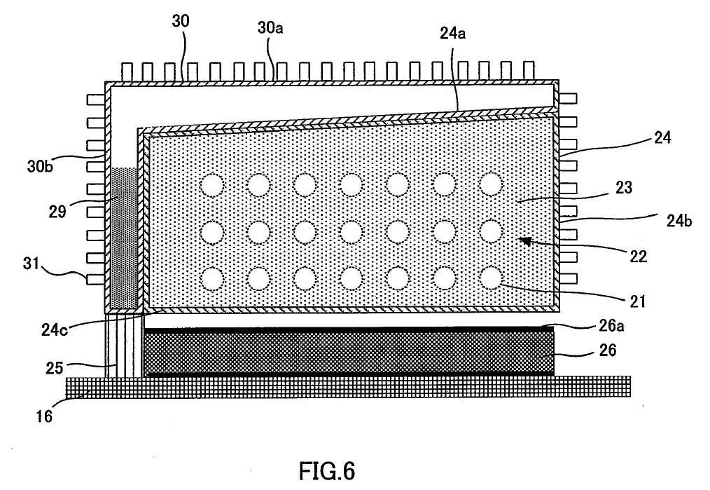

Alternatively, the power supply apparatus 2 can be formed as shown in FIG. 6 which is a section view showing Modification 1 of the power supply apparatus 2. A first medium housing case portion 30b is formed only partially on an outer surface of a case side-wall portion 24b. It should be noted that the specification is interpreted such that the medium housing case 30 holds the power supply case 24 including the case where the medium housing case 30 is in contact with part of the outer surface of the power supply case 24.

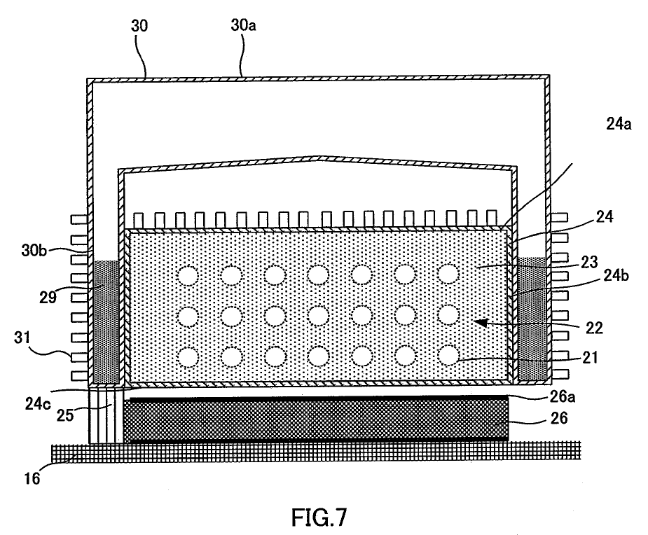

Alternatively, the power supply apparatus 2 can be formed as shown in FIG. 7 which is a section view showing Modification 2 of the power supply apparatus 2. A case upper-wall portion 24a of a power supply case 24 is not in contact with a second medium housing case portion 30a. A first medium housing case portion 30b is in contact with the whole outer surface of a case side-wall portion 24b of the power supply case 24. A plurality of heat-radiating fins 31 are formed on the case upper-wall portion 24a.

Since external heat at a high temperature is moved upward, such a structure can be used when a small amount of external heat flows through the case upper-wall portion 24a. This allows efficient radiation of heat in the assembled battery 22 by using the heat-radiating fins 31 formed on the case upper-wall portion 24a when the assembled battery 22 should be cooled.

Alternatively, the distribution of temperature in the assembled battery 22 in charge and discharge may be previously measured and the piezoelectric element 26 may be placed only in an area corresponding to an area (or a plurality of areas) at a high temperature.

The piezoelectric element 26 may be fixed to the power supply case 24, or the piezoelectric element 26 may be supported between the power supply case 24 and the floor panel 16 (that is, the piezoelectric element 26 is not in contact with the power supply case 24 or the floor panel 16), and is brought into contact with both the power supply case 24 and the floor panel 16 when heat radiation is performed.

While the power supply apparatus 2 is placed under the passenger seat 11, it can be placed in a console box between seats, under a backseat, in a trunk room or the like.

### Embodiment 2

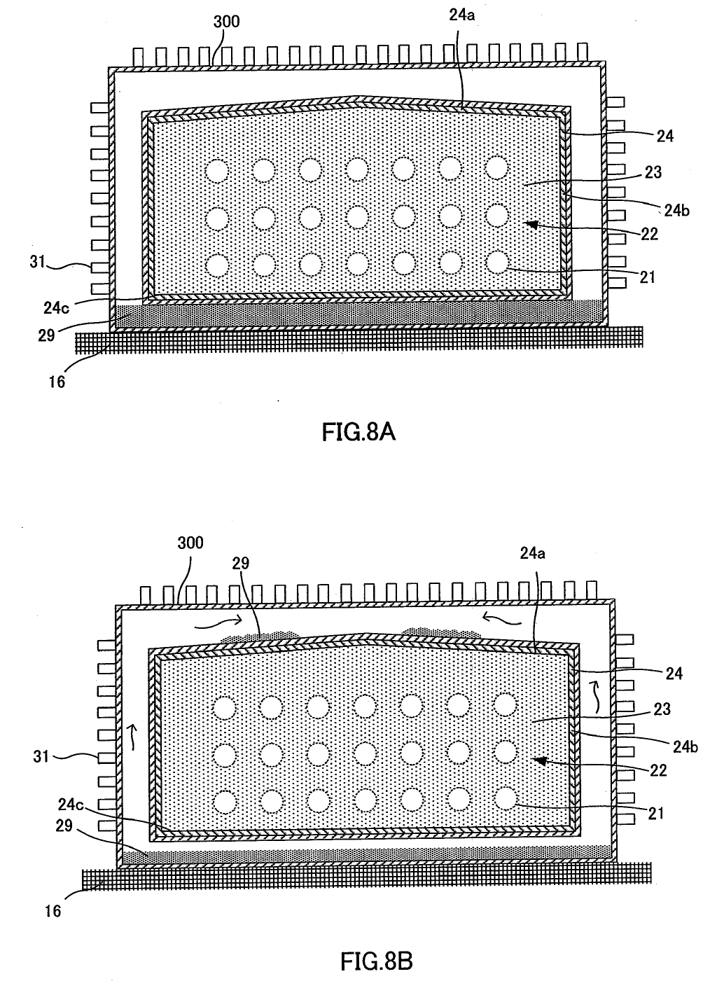

Next, Embodiment 2 of the present invention will be described with reference to FIGS. 8A and 8B which are section views showing a power supply apparatus of Embodiment 2. FIG. 8A shows the apparatus before a liquid medium 29 is vaporized and FIG. 8B shows the apparatus after part of the liquid medium 29 is vaporized. Portions identical to those of Embodiment 1 are designated with the same reference numerals.

A medium housing case (first case) 300 is placed to surround the whole outer surface of a power supply case 24. The liquid medium 29 is stored in a bottom portion of the medium housing case 300.

The liquid level of the liquid medium 29 before the temperature reaches a vaporization temperature is set to the same level as that of a case lower-wall portion 24c. In this case, since the liquid medium 29 is in contact with the case lower-wall portion 24c, heat exchange can be performed between the power supply case 24 and a floor panel 16 through the liquid medium 29.

On the other hand, when part of the liquid medium 29 is vaporized to reduce the liquid level as shown in FIG. 8B, an air layer is formed between the case lower-wall portion 24c and the liquid medium 29. The formed air layer (gas layer) prevents heat exchange between the power supply case 24 and the floor panel 16.

Next, the method of cooling an assembled battery 22 will be described in the respective cases where the ignition is off and the ignition is on in the vehicle.

### When Ignition is Off in Vehicle

When the ignition is off in the vehicle and the vehicle is parked under a high-temperature environment (for example, when .the vehicle is parked in a parking area exposed to direct sunlight), external heat maybe transferred from the floor panel 16 to vaporize part of the liquid medium 29 stored in the bottom portion of the medium housing case 300 (see FIG. 8B).

The external heat flowing into the power supply case 24 through the floor panel 16 is cooled through evaporation cooling, and the lowered liquid level of the liquid medium 29 forms the air layer between the case lower-wall portion 24c and the liquid medium 29. The air layer can prevent transfer of the heat in the floor panel 16 to the power supply case 24.

### When Ignition is On in Vehicle

When the vehicle is parked in a high-temperature environment, the air layer formed between the case lower-wall portion 24c and the liquid medium 29 at the start of driving of the vehicle prevents escape of the heat in the assembled battery 22 to the floor panel 16.

It is contemplated, however, that the temperature of the floor panel 16 is gradually reduced through air cooling associated with the driving of the vehicle to return the vaporized liquid medium 29 to a liquid state. Thus, if the assembled battery 22 generates heat during the driving of the vehicle, the heat in the assembled battery 22 can be escaped toward the floor panel 16 through the liquid medium 29.

1. A power supply apparatus wherein a liquid medium is housed so as to provide an air layer in a first case which accommodates a power supply unit, and when the liquid medium is heated to a temperature higher than a vaporization temperature by external heat toward the power supply unit, the liquid medium is vaporized to increase the volume of the air layer to reduce heat conduction of the external heat toward the power supply unit.

2. The power supply apparatus according to claim 1, wherein the liquid medium is vaporized at a temperature lower than an upper limit of a proper temperature range for the power supply unit.

3. The power supply apparatus according to claim 1, wherein a heat-radiating fin is formed on an outer surface of the first case.

4. The power supply apparatus according to claim 1, wherein the first case includes a liquid housing portion which houses the liquid medium and a guide surface which guides the liquid medium to the liquid housing portion after the liquid medium is once vaporized by the external heat and then changed into a liquid.

5. The power supply apparatus according to claim 1, wherein the power supply unit includes a power supply portion and a second case which accommodates a coolant, the coolant cools the power supply portion, and the first case is in contact with an outer surface of the second case.

6. The power supply apparatus according to claim 5, comprising:
an electromechanical energy converting element which is placed between a vehicle heat-radiating portion for radiating heat in the power supply unit to the outside of a vehicle and the second case and is switched between a contact state in which the element is in contact with the second case and the vehicle heat-radiating portion in response to application of a voltage and a non-contact state in which the element is not in contact with the second case and/or the vehicle heat-radiating portion; and
a control means for controlling application of a voltage to the electromechanical energy converting element.

7. The power supply apparatus according to claim 5, comprising:
an electromechanical energy converting element which is placed between a vehicle heat-radiating portion for radiating heat in the power supply unit to the outside of a vehicle and the second case and is switched between a contact state in which the element is in contact with the second case and the vehicle heat-radiating portion in response to application of a voltage and a non-contact state in which the element is not in contact with the second case and/or the vehicle heat-radiating portion; and
a control circuit for controlling application of a voltage to the electromechanical energy converting element.
